(19) United States
(12) Patent Application Publication
(10) Pub. No.: US 2026/0161647 A1
(43) Pub. Date: Jun. 11, 2026

(54) QUERY PROCESSING SYSTEM AND METHOD THEREOF

(71) Applicant: SK hynix Inc., Icheon-si (KR)

(72) Inventor: Soo Jin KIM, Icheon-si (KR)

(21) Appl. No.: 19/170,807

(22) Filed: Apr. 4, 2025

(30) Foreign Application Priority Data
Dec. 9, 2024 (KR) 10-2024-0181601

(51) Int. Cl. G06F 16/2453; G06F 16/22

(52) U.S. Cl. CPC G06F 16/24539; G06F 16/2282

(57) ABSTRACT

A query processing system may comprise a storage device storing one or more data tables, each including one or more data units, a query predictor generating a prediction query based on analysis information for history queries received from a host and reading one or more data units, which correspond to the prediction query, a buffer storing the data units, a query parser parsing a target query received from the host to generate target parsing information, and a query analyzer determining whether target data units which are data units corresponding to the target parsing information are stored in the buffer, reading the target data units from the buffer when the target data units are stored in the buffer, and reading the target data units from the storage device when the target data units are not stored in the buffer.

### CROSS-REFERENCE TO RELATED APPLICATION

The present application claims priority under 35 U.S.C. § 119(a) to Korean patent application number 10-2024-0181601 filed in the Korean Intellectual Property Office on Dec. 9, 2024, which is incorporated herein by reference in its entirety.

### BACKGROUND

### 1. Technical Field

Embodiments of the disclosure relate to a query processing system and a method thereof.

### 2. Related Art

Advances in technologies such as artificial intelligence (AI), machine learning (ML), and large language models (LLMs) are driving demand for systems that require computing performance necessary to process and analyze large amounts of data in real-time.

In particular, LLMs such as recommendation systems or ChatGPT need to support users with queries (e.g., SQL) for reading data stored in a high-capacity database. To that end, a need exists for a system capable of processing queries in real-time and quickly generating responses to the queries.

### SUMMARY

Embodiments of the disclosure may provide a query processing system and a method thereof, which may enhance the speed of responding to queries by pre-reading data highly likely to be requested to be read by the host in a storage device.

Embodiments of the disclosure may also provide a query processing system and a method thereof, which may optimize query processing performance by performing optimal operation on received queries.

Objects of embodiments of the disclosure are not limited to those set forth herein, and other objects of the embodiments not mentioned herein will be apparent to one of ordinary skill in the art from the following description.

Embodiments of the disclosure may provide a query processing system comprising a storage device storing one or more data tables, each of the data tables including one or more data units, a query predictor generating a prediction query based on analysis information for history queries received from a host and reading one or more of data units, which correspond to the prediction query from the storage device, a buffer storing the data units read from the storage device, a query parser parsing a target query which is a query received from the host to generate target parsing information, and a query analyzer determining whether target data units which are data units corresponding to the target parsing information are stored in the buffer, reading the target data units from the buffer when the target data units are stored in the buffer, and reading the target data units from the storage device when the target data units are not stored in the buffer.

Embodiments of the disclosure may provide a query processing method comprising generating a prediction query based on analysis information about history queries received from a host, reading one or more of data units included in a data table corresponding to the prediction query from a storage device, storing the data units read from the storage device in a buffer, parsing a target query which is a query received from the host to generate target parsing information, reading target data units which are data units included in a data table corresponding to the target parsing information from the buffer when the target data units are stored in the buffer, and reading the target data units from the storage device when the target data units are not stored in the buffer.

Embodiments of the disclosure may provide a system comprising a storage device storing one or more data tables, each of the data tables including one or more data units, a buffer storing the data units read from the storage device and a query predictor generating a prediction query based on analysis information about history queries received from a host, selecting a data table corresponding to the prediction query from the storage device, and reading one or more of data units included in the selected data table from the storage device and storing the read data units in the buffer.

According to embodiments of the disclosure, it is possible to enhance the speed of responding to queries by pre-reading data highly likely to be requested to be read by the host in the storage device and to optimize query processing performance by performing optimal computation on received queries.

The effects of the disclosure are not limited to the foregoing objects, and other effects will be apparent to one of ordinary skill in the art from the following detailed description.

### BRIEF DESCRIPTION OF THE DRAWINGS

The disclosure will be more fully understood from the following detailed description and the accompanying drawings, which are provided for illustration only and are not intended to limit the disclosure.

FIG. 1 is a view illustrating an operation in which a query processing system generates and executes a prediction query according to embodiments of the present disclosure;

FIG. 2 is a view illustrating an operation in which a query processing system executes a target query received from a host according to embodiments of the present disclosure;

FIG. 3 is a flowchart illustrating an operation in which a query analyzer reads target data units according to embodiments of the present disclosure;

FIG. 4 illustrates an example of target data units according to embodiments of the present disclosure;

FIG. 5 illustrates an example of history query and analysis information according to embodiments of the present disclosure;

FIG. 6 illustrates an example of first change information and second change information according to embodiments of the present disclosure;

FIG. 7 illustrates an example of an operation in which a query predictor determines whether to generate a prediction query according to embodiments of the present disclosure;

FIG. 8 illustrates an operation in which a query predictor generates a prediction query based on history queries according to embodiments of the present disclosure;

FIG. 9 is a view illustrating an operation in which a query processing system generates response data to a target query according to embodiments of the present disclosure;

FIG. 10 illustrates a policy in which a query analyzer determines a pre-processing operation based on a first threshold number and a second threshold number according to embodiments of the present disclosure;

FIG. 11 illustrates an example of an operation in which a query processor generates response data according to a pre-processing operation according to embodiments of the present disclosure;

FIG. 12 illustrates another example of an operation in which a query processor generates response data according to a pre-processing operation according to embodiments of the present disclosure;

FIG. 13 is a view illustrating another example of an operation in which a query processor generates response data according to a pre-processing operation according to embodiments of the present disclosure; and

FIG. 14 is a diagram illustrating a query processing method according to embodiments of the present disclosure.

### DETAIL DESCRIPTION

Hereinafter, embodiments of the disclosure are described in detail with reference to the accompanying drawings. In assigning reference numerals to components of each drawing, the same components may be assigned the same numerals even when they are shown on different drawings. When determined to make the subject matter of the disclosure unclear, the detailed of the known art or functions may be skipped. As used herein, when a component “includes,” “has,” or “is composed of” another component, the component may add other components unless the component “only” includes, has, or is composed of” the other component. As used herein, the singular forms “a”, “an” and “the” are intended to include the plural forms as well, unless the context clearly indicates otherwise.

Such denotations as “first,” “second,” “A,” “B,” “(a),” and “(b),” may be used in describing the components of the present invention. These denotations are provided merely to distinguish a component from another, and the essence, order, or number of the components are not limited by the denotations.

In describing the positional relationship between components, when two or more components are described as “connected”, “coupled” or “linked”, the two or more components may be directly “connected”, “coupled” or “linked” “, or another component may intervene. Here, the other component may be included in one or more of the two or more components that are “connected”, “coupled” or “linked” to each other.

When such terms as, e.g., “after”, “next”, “after”, and “before”, are used to describe the temporal flow relationship related to components, operation methods, and fabricating methods, it may include a non-continuous relationship unless the term “immediately” or “directly” is used.

When a component is designated with a value or its corresponding information (e.g., level), the value or the corresponding information may be interpreted as including a tolerance that may arise due to various factors (e.g., process factors, internal or external impacts, or noise).

Hereinafter, various embodiments of the disclosure are described in detail with reference to the accompanying drawings.

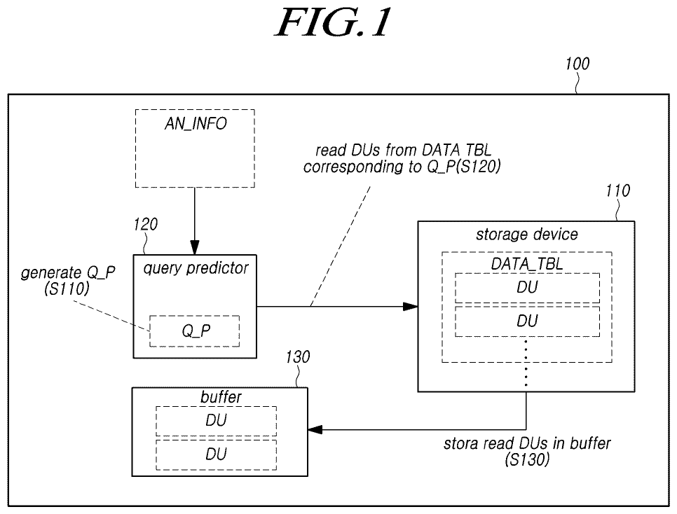

FIG. 1 is a view illustrating an operation in which a query processing system generates and executes a prediction query according to embodiments of the present disclosure.

Referring to FIG. 1, a query processing system 100 may include a storage device 110, a query predictor 120, and a buffer 130.

The storage device 110 may store one or more data tables DATA_TBL. Each data table DATA_TBL may include one or more data units DU. Each data table DATA_TBL may be compressed and stored in the storage device 110, and the storage device 110 may decompress the table in the process of reading the data units DU stored in the data table DATA_TBL.

For example, the data table DATA_TBL may be a table of a database. The table of the database may store data in the form of a table composed of rows and columns. One data unit DU included in the data table DATA_TBL may correspond to one row of the table of the database and include values of identifiers corresponding to each column of the table of the database.

The storage device 110 may be implemented as any device capable of storing data. For example, the storage device 110 may be implemented as a device that stores data on a magnetic disk, such as hard disk drive, or a device that stores data in semiconductor memory (non-volatile memory or volatile memory), such as solid state drive, or memory card

The semiconductor memory may be implemented as static random access memory, dynamic random access memory, NAND flash memory, 3D NAND flash memory, NOR flash memory, resistive random access memory (RRAM), phase-change memory (PRAM), magnetoresistive random access memory (MRAM), ferroelectric random access memory (FRAM), or spin transfer torque random access memory (STT-RAM).

The query predictor 120 may generate a prediction query Q_P based on the analysis information AN_INFO (S110).

The analysis information AN_INFO is information about a history query received from the host by the query processing system 100.

A history query may be a query received from the host before a reference time at which the query predictor 120 is set. For example, the reference time may be a current time (the time at which the query predictor 120 generates a prediction query Q_P) or any time in the past.

The query predictor 120 may identify an access trend based on information about a first query previously received by the query processing system 100 and, based thereon, predict a second query that is highly likely to be received from the host later.

The analysis information AN_INFO may be stored in the query processing system 100. For example, the analysis information AN_INFO may be included in the volatile memory or the nonvolatile memory included in the query processing system 100. In other examples, the analysis information AN_INFO may be stored in the storage device 110.

Further, the query predictor 120 may read one or more of the data units DU included in the data table DATA_TBL corresponding to the prediction query Q_P from the storage device 110 (S120).

For example, the query predictor 120 may request a read requester (not shown) to transmit a read command to the storage device 110 to read from the storage device 110. In response, the read requester may transmit a read command to the storage device 110, receive a response to the read command from the storage device 110, and transmit the response to the query predictor 120.

The query predictor 120 may execute the operation in step S120 during an idle time or in parallel with a read operation for another query.

The query predictor 120 may be implemented in various ways. For example, the query predictor 120 may be implemented as an integrated circuit including logic gates for executing the above-described operations. The query predictor 120 may be implemented as an application specific integrated circuit (ASIC), a field programmable gate array (FPGA), or the like.

In other examples, the query predictor 120 may be implemented as a processing unit (e.g., a CPU, GPU, or microprocessor) that executes data in which code for executing the above-described operation is defined.

The buffer 130 may store the data units DUs read in step S120 (S130). For example, the buffer 130 may be implemented as a semiconductor memory included in the query processing system 100.

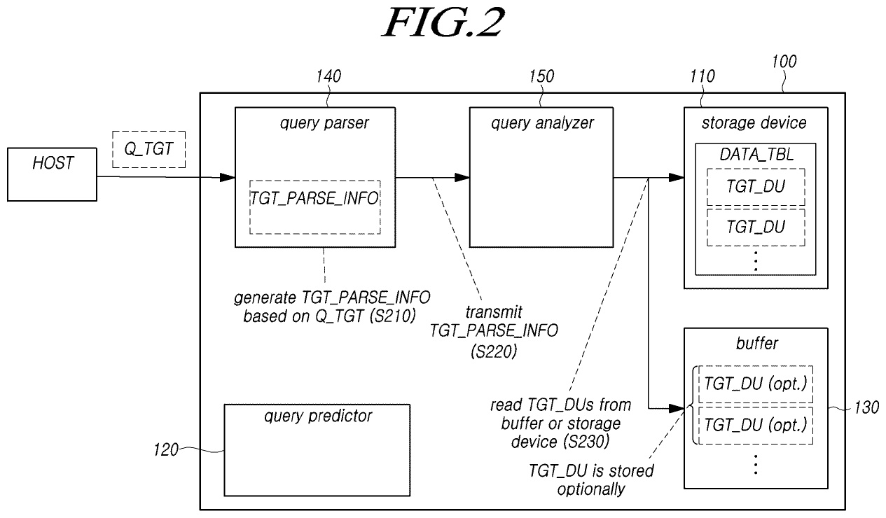

FIG. 2 is a view illustrating an operation in which a query processing system executes a target query received from a host according to embodiments of the present disclosure.

Referring to FIG. 2, a query processing system 100 may further include a query parser 140 and a query analyzer 150 in addition to a storage device 110, a query predictor 120, and a buffer 130 described above with reference to FIG. 1.

The query parser 140 may parse a target query Q_TGT, which is a query received from a host HOST, to generate target parsing information TGT_PARSE_INFO (S210). The target query Q_TGT may be a query received from the host HOST after the query processing system 100 receives a history query as described above with reference to FIG. 1.

The target parsing information TGT_PARSE_INFO may include information about keywords, operators, and identifiers stored in the target query Q_TGT. For example, if the target query Q_TGT is “select * from WineTable where Type=Red and Taste=Dry and Price<30”, the target parsing information TGT_PARSE_INFO may include the keywords {select, from, where}, the operators {and, and, =, =, <}, and the identifiers {WineTable, Type, Taste, Price}.

The target parsing information TGT_PARSE_INFO generated by the query parser 140 may be stored in the query processing system 100. For example, the target parsing information TGT_PARSE_INFO may be stored in the storage device 110 or the buffer 130. As another example, the target parsing information TGT_PARSE_INFO may be stored in a separate volatile memory in the query processing system 100 allocated to store the target parsing information TGT_PARSE_INFO.

The query parser 140 may transmit target parsing information TGT_PARSE_INFO to the query analyzer 150 (S220).

The query analyzer 150 may receive the target parsing information TGT_PARSE_INFO and read, from the storage device 110 or the buffer 130, the target data units TGT_DU, which are data units included in the data table DATA_TBL corresponding to the target parsing information TGT_PARSE_INFO (S230).

To that end, the query analyzer 150 may manage identifiers required to process the target query Q_TGT and request count information according to the value of each of the identifiers. For example, the query analyzer 150 may manage request counts for the values {Red, White, Rose, Sparkling, . . . } for the identifier Type and request counts for the values {Dry, Medium dry, Medium, Sweet, Medium sweet, . . . } for the identifier Taste. The query analyzer 150 may sort the request count information (e.g., count values for Type and Taste) according to the order in which the values of the identifiers are requested by the host. Further, the query analyzer 150 may add identifiers and request count information about each identifier in the analysis information AN_INFO described above.

The storage device 110 may store target data units TGT_DU.

Further, the buffer 130 may optionally store the target data units TGT_DU. Accordingly, the target data units TGT_DU stored in the storage device 110 may be stored together in the buffer 130 or may be stored only in the storage device 110.

If the query predictor 120 reads the target data units TGT_DU based on the previously generated prediction query Q_P, the buffer 130 may be in a state of storing the target data units TGT_DU associated with prediction query Q_P. On the other hand, if the query predictor 120 has not previously read the target data units TGT_DU, the buffer 130 may be in a state of not storing the target data units TGT_DU associated with prediction query Q_P.

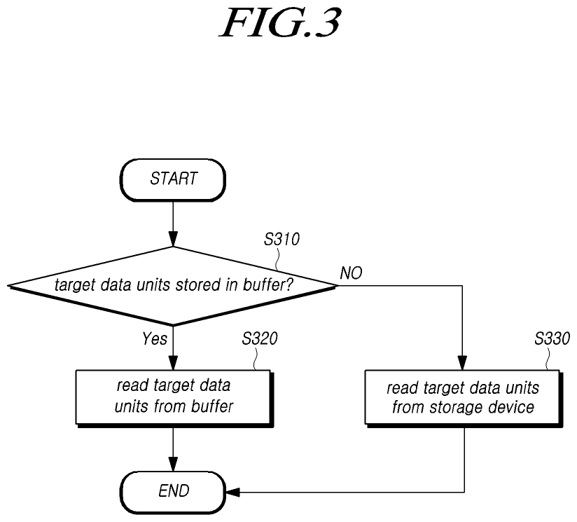

Hereinafter, an operation in which the query analyzer 150 reads target data units TGT_DU is described in detail with reference to FIG. 3.

FIG. 3 is a flowchart illustrating an operation in which a query analyzer reads target data units according to embodiments of the present disclosure.

First, a query analyzer 150 determines whether target data units TGT_DU are stored in a buffer 130 (S310).

When the target data units TGT_DU are stored in a buffer 130 (S310—Y), the query analyzer 150 may read the target data units TGT_DU from the buffer 130 (S320).

When target data units TGT_DU are stored in the buffer 130, the query analyzer 150 may generate a response to the target query Q_TGT using the target data units TGT_DU already stored in buffer 130 without the need for an additional a read command to read the target data units TGT_DU transmitted to the storage device 110 by the query analyzer 150 or another component(e.g. read requester). Accordingly, response speed to a target query Q_TGT may be enhanced.

Referring back to FIG. 3, when the target data units TGT_DU are not stored in the buffer 130 (S310—N), the query analyzer 150 may read the target data units TGT_DU from the storage device 110. In this case, it may take an additional time for the query analyzer 150 because the query analyzer should read the target data units TGT_DU from the storage device 110.

Like the query predictor 120, the query parser 140 and the query analyzer 150 may be implemented in various ways. For example, the query parser 140 and the query analyzer 150 may be implemented as an integrated circuit (e.g., application specific integrated circuit (ASIC) or field programmable gate array (FPGA) including logic gates for executing the above-described operations.

As another example, the query parser 140 and the query analyzer 150 may be implemented as a processing unit (e.g., CPU, GPU, and microprocessor) that executes data in which the code for executing the above-described operations is defined.

Specific operations of each component of the query processing system 100 have been described above.

Hereinafter, operations of each component of the query processing system 100 are described by using a specific data table as an example.

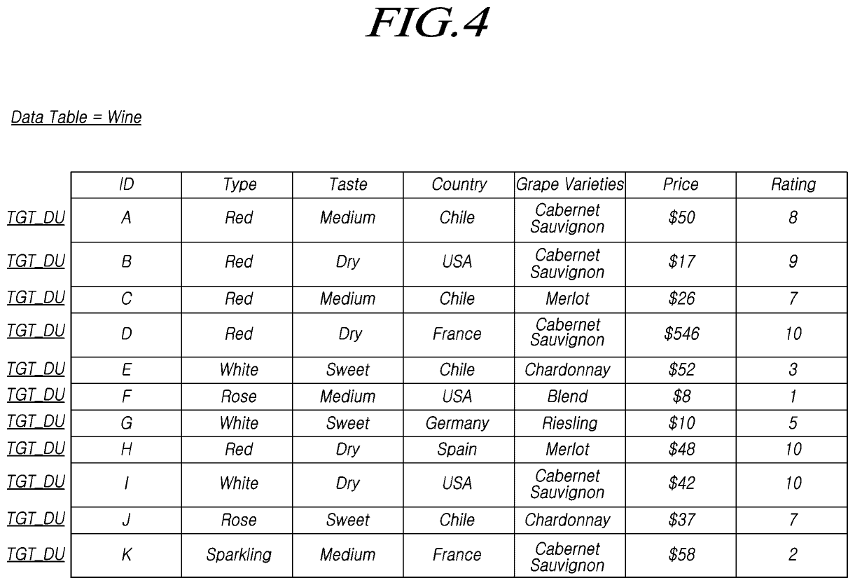

FIG. 4 illustrates an example of target data units according to embodiments of the present disclosure.

FIG. 4 illustrates target data units TGT_DU stored in a data table Wine.

Referring to FIG. 4, the data table Wine may include 11 target data units TGT_DU.

Each of the target data units TGT_DU may store a value for each of a plurality of identifiers. In FIG. 4, the target data units TGT_DU may store values for identifiers such as {ID, Type, Taste, Country, Grape variables, Price, and Rating}.

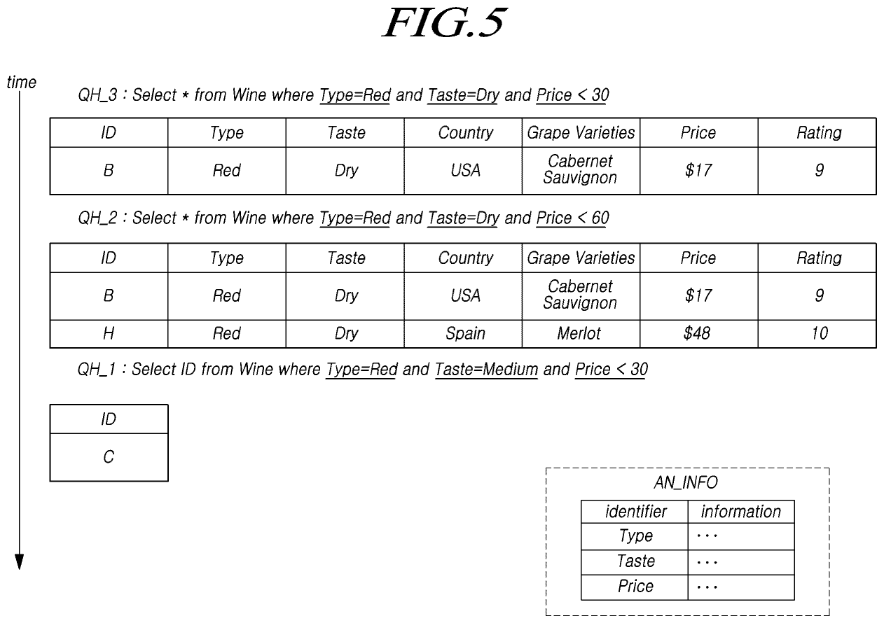

FIG. 5 illustrates an example of history queries and analysis information according to embodiments of the present disclosure.

Referring to FIG. 5, analysis information AN_INFO may include information about identifiers included in first history query QH_1 and second history query QH_2 received from host HOST. Each identifier is an attribute or combination of attributes that distinguish entities included in the data table, and may be used to distinguish information included in the data table from each other.

In this example, the first history query QH_1 is the most recently received query among the history queries. The second history query QH_2 is a query received from the host HOST immediately before the first history query QH_1.

In FIG. 5, the first history query QH_1 is “Select ID from Wine where Type=Red and Taste=Medium and Price<30”. Query processing system 100 may output C to the host HOST, where C is the ID of the data unit corresponding to the first history query QH_1 in the data table Wine disclosed in FIG. 4.

The second history query QH_2 is “Select * from Wine where Type=Red and Taste=Dry and Price<60”. The query processing system 100 may output to the host HOST the data unit having ID=B and ID=H corresponding to the second history query QH_2 in the data table Wine disclosed in FIG. 4.

Further, the analysis information AN_INFO may additionally include information about identifiers included in third history query QH_3. The third history query QH_3 is a query received from the host HOST immediately before the second history query QH_2 is received.

The third history query QH_3 is “Select * from Wine where Type=Red and Taste=Dry and Price <30”. The query processing system 100 may output to the host HOST the data unit having ID=B corresponding to the third history query QH_3 in the data table Wine disclosed in FIG. 4.

Here, identifiers included in the first history query QH_1 and the second history query QH_2 are {Type, Taste, Price}. Therefore, the analysis information AN_INFO may include information about the identifiers {Type, Taste, Price}.

The analysis information AN_INFO may be generated by an above-described query analyzer 150. When the query processing system 100 receives the above-described history query, query parser 140 may generate parsing information for the history query, and the query analyzer 150 may update the analysis information AN_INFO using the parsing information for the history query.

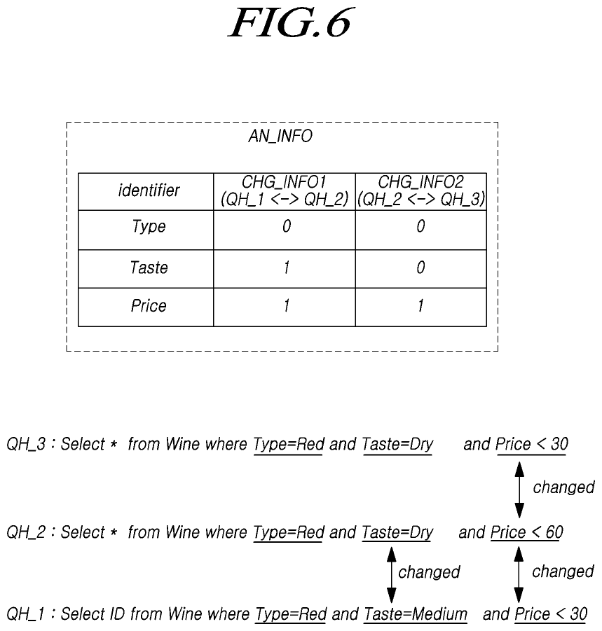

FIG. 6 illustrates an example of first change information and second change information according to embodiments of the present disclosure.

In embodiments of the present disclosure, the analysis information AN_INFO may include first change information CHG_INFO1 and second change information CHG_INFO2 for identifiers included in both the first history query QH_1 and the second history query QH_2.

The first change information CHG_INFO1 of each identifier indicates

whether at least one of an operator and values corresponding to the identifier is changed between the first history query QH_1 and the second history query QH_2.

If the first change information CHG_INFO1 is a first value (e.g., 1), then at least one of the operator and the value is changed between the first history query QH_1 and the second history query QH_2, and if CHG_INFO1 is a second value (e.g., 0), then neither the operator nor the value is changed.

The second change information CHG_INFO2 of each identifier indicates whether at least one of the operator and value corresponding to the identifier is changed between the second history query QH_2 and the third history query QH_3. If the second change information CHG_INFO2 is a first value (e.g., 1), then at least one of the operator and the value is changed between the second history query QH_2 and the third history query QH_3, and CHG_INFO2 is a second value (e.g., 0), then neither the operator nor the value is changed.

In FIG. 6, when comparing the first history query QH_1 and the second history query QH_2, there is no change in the operator and value for the identifier Type, the value for the identifier Taste is changed from Dry to Medium, and the value for the identifier Price is changed from 60 to 30. Therefore, the values of the first change information CHG_INFO1 for the identifiers {Type, Taste, Price} are {0, 1, 1} respectively.

When comparing the second history query QH_2 and the third history query QH_3, there is no change in operator and value for the identifier Type, no change in operator and value for the identifier Taste, and the value for the identifier Price is changed from 30 to 60. Therefore, the values of the second change information CHG_INFO2 for the identifiers {Type, Taste, Price} are {0, 0, 1} respectively.

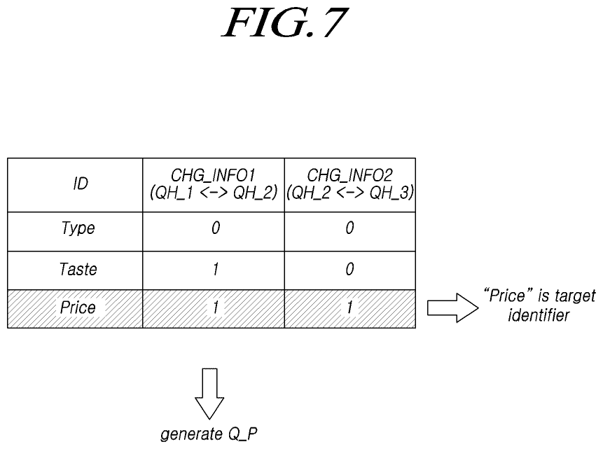

FIG. 7 illustrates an example of an operation in which a query predictor determines whether to generate a prediction query according to embodiments of the present disclosure.

In embodiments of the present disclosure, a query predictor 120 may

search for a target identifier based on first change information CHG_INFO1 and second change information CHG_INFO2. The target identifier is an identifier changed in both the first history query QH_1 and the second history query QH_2, and the values of the first change information CHG_INFO1 and the second change information CHG_INFO2 both are the first value (e.g., 1).

When the query predictor 120 succeeds in searching for the target identifier, the query predictor 120 may generate a prediction query Q_P. On the other hand, when the search for the target identifier fails, the query predictor 120 may not generate the prediction query Q_P.

The query predictor 120 may initialize the values of the first change information CHG_INFO1 and the second change information CHG_INFO2 after generating the prediction query Q_P.

In FIG. 7, among the identifiers {Type, Taste, Price}, the identifier Price, in which the first change information CHG_INFO1 and the second change information CHG_INFO2 both are 1, is the target identifier.

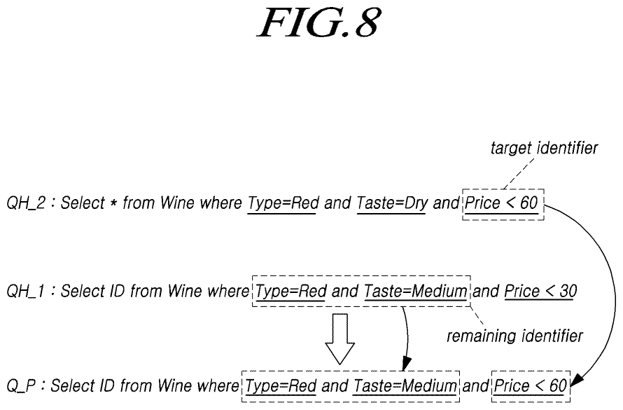

FIG. 8 illustrates an example of an operation in which a query predictor generates a prediction query based on history queries according to embodiments of the present disclosure.

In embodiments of the present disclosure, the query predictor 120 may include identifiers that overlap between the first history query QH_1and the second history query QH_2, which can be used as an identifier of the prediction query Q_P.

A query predictor 120 may determine an operator and a value corresponding to a target identifier in the prediction query Q_P as the operator and value corresponding to a target identifier in the second history query QH_2.

Further, the query predictor 120 may determine the operators and values of the remaining identifiers, except for the target identifier in the prediction query Q_P, as the operators and values corresponding to the remaining identifiers in the first history query QH_1.

In FIG. 8, the identifiers that are the same in the first history query QH_1 and the second history query QH_2 are {Type, Taste, Price}. Therefore, the prediction query Q_P may also include one or more of the identifiers {Type, Taste, Price}.

In FIG. 7 described above, among the identifiers {Type, Taste, Price}, Price is the target identifier. Therefore, the operator and value of the target identifier Price in the prediction query Q_P may be determined as <60, which is a value corresponding to the target identifier Price in the second history query QH_2.

For the remaining identifiers {Type, Taste}, the values of the remaining identifiers {Type, Taste} in the prediction query (Q_P) may be determined as =Red and =Medium, respectively, as the operators and values corresponding to the remaining identifiers {Type, Taste} in the first history query QH_1.

The operation of generating the prediction query Q_P by the query processing system 100 has been described above.

Hereinafter, an operation in which the query processing system 100 generates response data to the target query Q_TGT received from the host HOST is described.

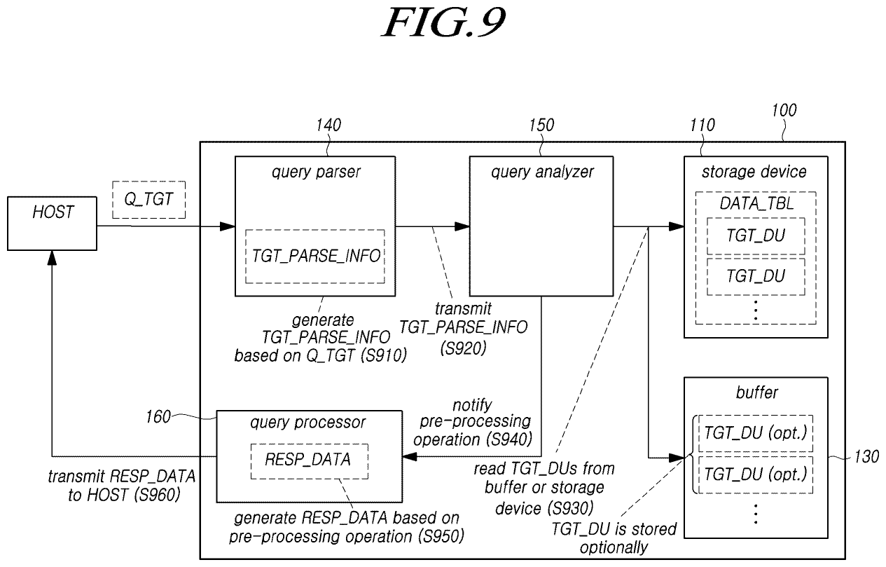

FIG. 9 is a view illustrating an operation in which a query processing system generates response data to a target query according to embodiments of the present disclosure.

Referring to FIG. 9, a query parser 140 may parse target query Q_TGT received from host HOST to generate target parsing information TGT_PARSE_INFO (S910).

The query parser 140 may transmit target parsing information TGT_PARSE_INFO to a query analyzer 150 (S920).

Further, the query analyzer 150 may read target data units TGT_DU from a buffer 130 or a storage device 110 (S930). As described above, the storage device 110 may store target data units TGT_DU, and the buffer 130 may optionally store target data units TGT_DU.

In FIG. 9, a query processing system 100 may further include a query processor 160. The query processor 160 may generate response data RESP_DATA, which is data to be transmitted to the host HOST, as a response to the target query Q_TGT.

In FIG. 9, the query analyzer 150 may determine a pre-processing operation to be performed on the target data units TGT_DU read in step S930, and notify the query processor 160 of the same (S940).

Further, the query processor 160 may perform a pre-processing operation on the target data units TGT_DU to generate response data RESP_DATA (S950). According to the pre-processing operation, the query processor 160 may perform a coarse processing operation or a fine processing operation on the target data units TGT_DU.

The query processor 160 may transmit the generated response data RESP_DATA to the host HOST (S960).

Like the query predictor 120, the query parser 140, and the query analyzer 150, the query processor 160 may also be implemented in various ways. For example, the query processor 160 may be implemented as an integrated circuit (e.g., application specific integrated circuit (ASIC) or field programmable gate array (FPGA) including logic gates for executing the above-described operation.

As another example, the query processor 160 may be implemented as a processing unit (e.g., CPU, GPU, or microprocessor) that executes data in which code for executing the above-described operation is defined.

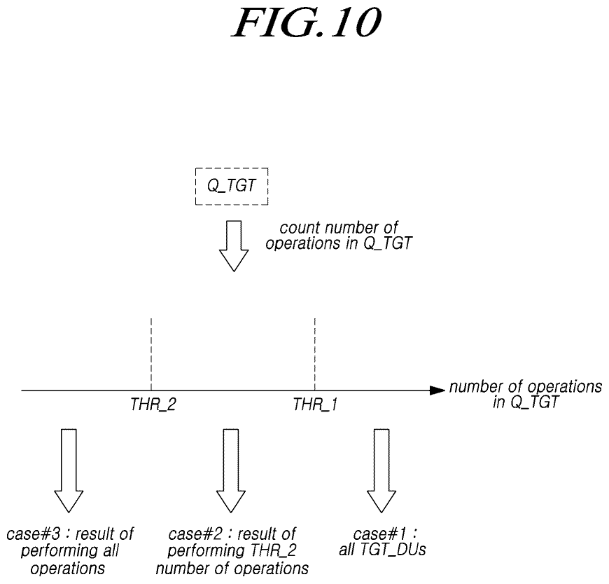

FIG. 10 illustrates a policy in which a query analyzer determines a

pre-processing operation based on a first threshold number and a second threshold number according to embodiments of the present disclosure.

Referring to FIG. 10, a query analyzer 150 may count the number of operations included in a target query Q_TGT. The operation may be determined by a combination of identifiers, operators, and values included in the target query Q_TGT.

Further, the query analyzer 150 may determine the pre-processing operation based on a result of comparing the number of operations included in the target query Q_TGT with at least one of a first threshold number THR_1 and a second threshold number THR_2.

In FIG. 5, the first threshold number THR_1 is larger than the second threshold number THR_2.

The values of the first threshold number THR_1 and the second threshold number THR_2 may be values internally set by the query analyzer 150 or values received from the host HOST.

The pre-processing operation determined by the query analyzer 150 is executed by the query processor 160 described above. The query analyzer 150 determines an optimal pre-processing operation, and the query processor 160 executes it, thereby reducing the size of the response data RESP_DATA transmitted to the host HOST and consequently enhancing processing performance for the target query Q_TGT.

The method for determining the pre-processing operation may be one of three methods as determined by query analyzer 150.

First, when the number of operations included in the target query Q_TGT is larger than the first threshold number THR_1, the query analyzer 150 may determine an operation of extracting all target data units TGT_DU corresponding to identifiers included in the target query as the pre-processing operation (case #1).

When the number of operations included in the target query Q_TGT is smaller than or equal to the first threshold number THR_1 and larger than the second threshold number THR_2, the query analyzer 150 may determine an operation of performing a second threshold number THR_2 of operations among the operations included in the target query Q_TGT as the pre-processing operation (case #2).

For example, the query analyzer 150 may determine the operation of performing a second threshold number THR_2 of operations specified first among the operations included in the target query Q_TGT on the target data units TGT_DU as the pre-processing operation.

When the number of operations included in the target query Q_TGT is smaller than or equal to the second threshold number THR_2, the query processor 160 may determine an operation of performing all of the operations included in the target query Q_TGT on the target data units TGT_DU as the pre-processing operation (case #3).

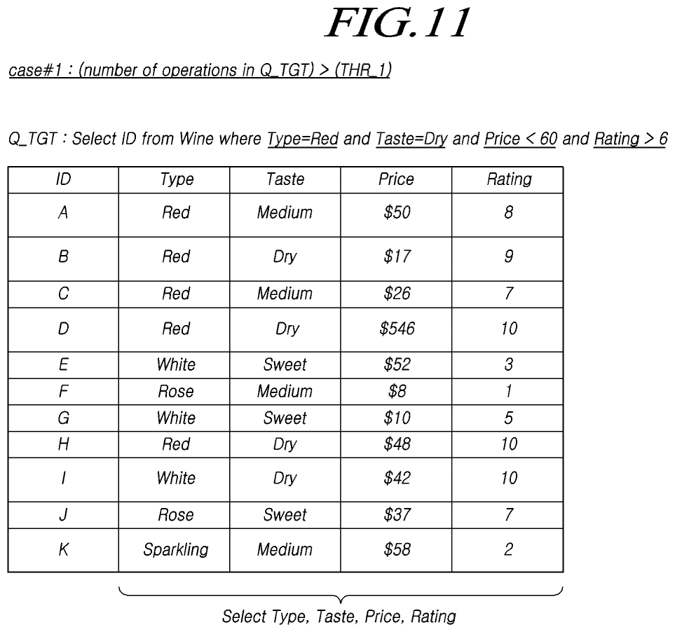

FIG. 11 illustrates an example of an operation in which a query processor generates response data according to a pre-processing operation

according to embodiments of the present disclosure.

In FIG. 11, target query Q_TGT is “Select ID from Wine where Type=Red and Taste=Dry and Price<60 and Rating>6”. Here, the operations are {“Type=Red”, “Taste=Dry”, “Price<60”, “Rating>6”}, and the number of the operations is 4.

FIG. 11 illustrates case #1 described above with reference to FIG. 10, namely, a case where the number of operations included in the target query Q_TGT is larger than the first threshold number THR_1. For example, the first threshold number THR_1 is 3, and the number of operations is 4,which is larger than the first threshold number THR_1, i.e., 3.

In this case, the query analyzer 150 may determine, as the pre-processing operation, an operation of extracting a portion corresponding to the identifiers {Type, Taste, Price, Rating} corresponding to the operations included in the target query Q_TGT from the target data units TGT_DU.

Accordingly, the query processor 160 may determine the result of extracting a portion corresponding to the identifiers {Type, Taste, Price, Rating} from all of the target data units TGT_DU as the response data RESP_DATA, for the target data units TGT_DU.

Since the operations corresponding to the identifiers {Country, Grape variables} are not present in the target query Q_TGT, the portion corresponding to the identifiers {Country, Grape variables} is not included in the response data RESP_DATA. Therefore, the size of the response data RESP_DATA transmitted to the host HOST is reduced as compared with the size of all of the target data units TGT_DU.

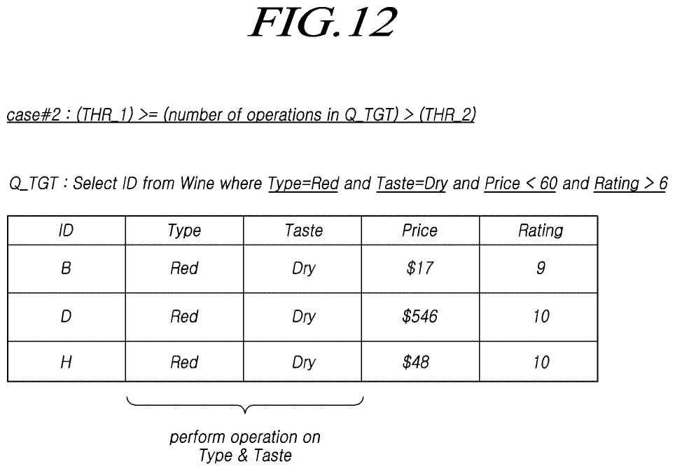

FIG. 12 illustrates another example of an operation in which a query processor generates response data according to a pre-processing operation according to embodiments of the present disclosure.

In FIG. 12, target query Q_TGT is “Select ID from Wine where Type=Red and Taste=Dry and Price<60 and Rating>6”. Here, the operations are {“Type=Red”, “Taste=Dry”, “Price<60”, “Rating>6”}, and the number of the operations is 4.

FIG. 12 illustrates case #2 described above with reference to FIG. 10, namely, a case where the number of operations included in the target query Q_TGT is the first threshold number THR_1 or less, and also larger than the second threshold number. For example, the first threshold number THR_1 is 5 and the second threshold number THR_2 is 2, and the number of operations (i.e., 4) may be equal to or smaller than 5, which is the first threshold number THR_1, and the number of operations may be larger than 2, which is the second threshold number THR_2.

In this case, query analyzer 150 may determine, as the pre-processing operation, an operation of performing two (i.e., the second threshold number THR_2) of the operations {“Type=Red”, “Taste=Dry”, “Price<”, “Rating>6”} included in the target query Q_TGT.

For example, the query analyzer 150 may determine an operation of performing a second threshold number THR_2 of operations {“Type=Red”, “Taste=Dry”} first specified among the operations {“Type=Red,” “Taste=Dry,” “Price<60,” “Rating>6”} as the pre-processing operation.

Accordingly, the query processor 160 may search for target data units (ID=B, D, H) in which the value of Type is Red and the value of Taste is Dry among the target data units TGT_DU. The query processor 160 may determine the response data RESP_DATA using only three target data units with IDs=B, D, and H among the target data units TGT_DU.

As in the example illustrated in FIG. 11, since the operations corresponding to the identifiers {Country, Graph variables} are not present in the target query Q_TGT, the portion corresponding to the identifiers {Country, Graph variables} may not be included in the response data RESP_DATA.

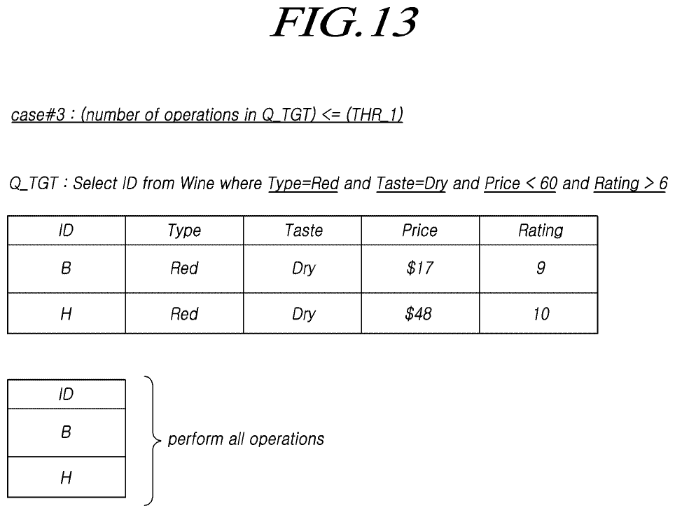

FIG. 13 is a view illustrating another example of an operation in which a query processor generates response data according to a pre-processing operation according to embodiments of the present disclosure.

In FIG. 13, target query Q_TGT is “Select ID from Wine where Type=Red and Taste=Dry and Price<60 and Rating>6”. Here, the operations are {“Type=Red”, “Taste=Dry”, “Price<60”, “Rating>6”}, and the number of the operations is 4.

FIG. 13 illustrates case #3 described above, namely, a case in which the number of operations included in the target query Q_TGT is smaller than or equal to the second threshold number. For example, the second threshold number THR_2 may be 5, and the number of operations (i.e., 4), may be equal to or smaller than 5, which is the second threshold number THR_2.

In this case, the query analyzer 150 may determine, as the pre-processing operation, an operation of performing all of the operations {“Type=Red”, “Taste=Dry”, “Price<60”, “Rating>6”} included in the target query Q_TGT on the target data units TGT_DU, for the target data units TGT_DU.

Therefore, the query processor 160 may search for target data units (ID=B, H) in which the value of Type is Red, the value of Taste is Dry, and Price is smaller than 60 and the Rating is larger than 6.

The query processor 160 may determine the value ID=B and H for the identifier ID requested by the target query Q_TGT as the response data RESP_DATA for two target data units with ID=B and H among the target data units TGT_DU.

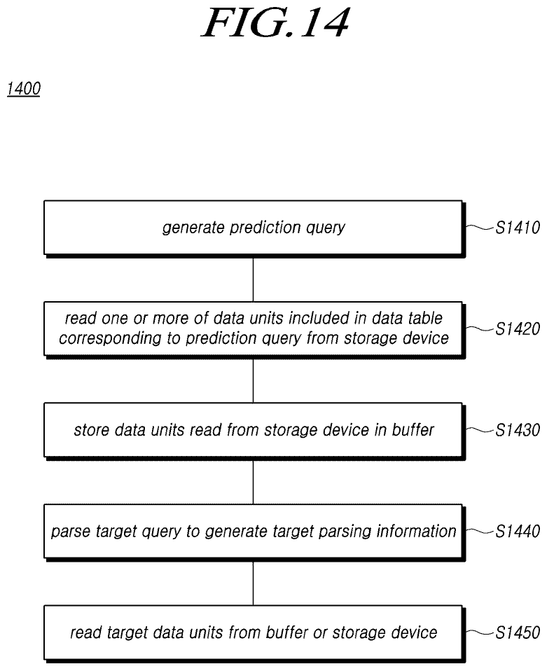

FIG. 14 is a diagram illustrating a query processing method according to embodiments of the present disclosure.

Referring to FIG. 14, a query processing method 1400 may include a step S1410 of generating a prediction query Q_P based on analysis information AN_INFO about the history queries received from a host HOST.

For example, the analysis information AN_INFO may include information about identifiers that are the same in a first history query QH_1 and a second history query QH_2 received from the host HOST. The first history query QH_1 is the most recently received query among the history queries, and the second history query QH_2 is the query received immediately before the first history query QH_1.

The analysis information AN_INFO may include first change information CHG_INFO1 and second change information CHG_INFO2 for each of the identifiers that overlap between the first history query QH_1 and the second history query QH_2. The first change information CHG_INFO1 indicates whether at least one of the operator and value corresponding to each of the identifiers is changed between the first history query QH_1 and the second history query QH_2, and the second change information CHG_INFO2 indicates whether at least one of the operator and value corresponding to each of the identifiers is changed between the second history query QH_2 and the third history query QH_3. The third history query QH_3 is a query received immediately before the second history query QH_2.

In step S1410, a target identifier, which is an identifier that has been changed in both the first history query QH_1 and the second history query QH_2, may be searched based on the above-described first change information CHG_INFO1 and the second change information CHG_INFO2, and a prediction query Q_P may be generated when the target identifier meeting the criteria is successfully found.

Step S1410 may include the identifiers that overlap between in the first history query QH_1 and the second history query QH_2 and that can be used as target identifiers of the prediction query Q_P. An operator and a value corresponding to a target identifier in the prediction query Q_P may be determined and correspond to the target identifier in the second history query QH_2. The operators and values of the remaining identifiers in the prediction query Q_P may be the operators and values corresponding to the remaining identifiers in the first history query QH_1.

The query processing method 1400 may include a step S1420 of reading one or more of the data units included in the data table corresponding to the prediction query Q_P from the storage device 110.

The query processing method 1400 may include a step S1430 of storing the data units read from the storage device 110 in the buffer 130.

The query processing method 1400 may include a step S1440 of parsing the target query Q_TGT, which is a query received from the host HOST, to generate target parsing information TGT_PARSE_INFO.

The query processing method 1400 may include a step S1450 of reading, from the buffer 130 or the storage device 110, target data units TGT_DU, which are data units included in the data table corresponding to the target parsing information TGT_PARSE_INFO.

Step S1450 may include determining whether the target data units TGT_DU are stored in the buffer 130 and, when the target data units TGT_DU are stored in the buffer 130, reading the target data units TGT_DU from the buffer 130 and, when the target data units TGT_DU are not stored in the buffer 130, reading the target data units TGT_DU from the storage device 110.

The query processing method 1400 may further include generating response data RESP_DATA, which is data to be transmitted to the host HOST as a response corresponding to the target query Q_TGT.

Generating the response data RESP_DATA may include counting the number of operations included in the target query Q_TGT, determining a pre-processing operation to be performed on the target data unit TGT_DU based on a result of comparing the number of operations included in the target query Q_TGT with at least one of a first threshold number THR_1 and a second threshold number THR_2, and performing the pre-processing operation on the target data units TGT_DU to generate the response data RESP_DATA, where the first threshold number THR_1 is larger than the second threshold number THR_2.

For example, when the number of operations included in the target query Q_TGT is larger than the first threshold number THR_1, generating the response data RESP_DATA may determine an operation of extracting a portion corresponding to identifiers included in the target query Q_TGT from the target data units TGT_DU as the pre-processing operation.

As another example, when the number of operations included in the target query Q_TGT is smaller than or equal to the first threshold number THR_1 and larger than the second threshold number THR_2, generating the response data RESP_DATA may determine an operation of performing a second threshold number THR_2 of operations among the operations included in the target query Q_TGT as the pre-processing operation. In this case, the second threshold number THR_2 of operations may be the second threshold number THR_2 of operations first specified among the operations included in the target query Q_TGT.

As another example, when the number of operations included in the target query Q_TGT is smaller than or equal to the second threshold number THR_2, generating the response data RESP_DATA may determine an operation of performing all of the operations included in the target query Q_TGT on the target data units TGT_DU as the pre-processing operation.

The above-described query processing method 1400 may be performed by a query processing system 100.

Although exemplary embodiments of the disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the disclosure is not limited by the embodiments and the accompanying drawings. The spirit and scope of the disclosure should be interpreted in connection with the appended claims and encompass all equivalents falling within the scope of the appended claims.

What is claimed is:

1. A query processing system, comprising:
a storage device storing one or more data tables, each of the data tables including one or more data units;
a query predictor generating a prediction query based on analysis information for history queries received from a host and reading one or more of data units, which correspond to the prediction query, from the storage device;
a buffer storing the data units read from the storage device;
a query parser parsing a target query, which is a query received from the host, to generate target parsing information; and
a query analyzer determining whether target data units, which are data units corresponding to the target parsing information, are stored in the buffer, reading the target data units from the buffer when the target data units are stored in the buffer, and reading the target data units from the storage device when the target data units are not stored in the buffer.

2. The query processing system of claim 1, wherein the analysis information includes information about identifiers that are included in both a first history query and a second history query received from the host, and
wherein the first history query is the most recently received query among the history queries, and the second history query is a query received immediately before the first history query.

3. The query processing system of claim 2, wherein the analysis information includes first change information and second change information about each of the identifiers included in both the first history query and the second history query, and
wherein the first change information indicates whether at least one of an operator and a value corresponding to each of the identifiers is changed between the first history query and the second history query, and the second change information indicates whether at least one of the operator and the value corresponding to each of the identifiers is changed between the second history query and a third history query received immediately before the second history query.

4. The query processing system of claim 3, wherein the query predictor searches for a target identifier, which is an identifier changed in both the first history query and the second history query, based on the first change information and the second change information and, when the search for the target identifier is successful, generates the prediction query.

5. The query processing system of claim 4, wherein the query predictor sets the identifiers that are included in both the first history query and the second history query as identifiers in the prediction query, determines an operator and a value corresponding to the target identifier in the prediction query as an operator and a value corresponding to the target identifier in the second history query, and determines an operator and a value of a remaining identifier, except for the target identifier, in the prediction query as an operator and a value corresponding to the remaining identifier in the first history query.

6. The query processing system of claim 1, further comprising a query processor generating response data which is data to be transmitted to the host as a response to the target query,
wherein the query analyzer counts a number of operations included in the target query and determines a pre-processing operation to be performed on the target data units based on a result of comparing the number of operations included in the target query with at least one of a first threshold number and a second threshold number,
wherein the query processor generates the response data by performing the pre-processing operation on the target data units, and
wherein the first threshold number is larger than the second threshold number.

7. The query processing system of claim 6, wherein the query analyzer determines an operation of extracting a portion corresponding to identifiers included in the target query in the target data units as the pre-processing operation when the number of operations included in the target query is larger than the first threshold number.

8. The query processing system of claim 6, wherein the query analyzer determines an operation of performing the second threshold number of operations among the operations included in the target query on the target data units as the pre-processing operation when the number of operations included in the target query is the first threshold number or less and is larger than the second threshold number.

9. The query processing system of claim 8, wherein the query analyzer determines an operation of performing the second threshold number of operations first specified among the operations included in the target query on the target data units as the pre-processing operation.

10. The query processing system of claim 6, wherein the query processor determines an operation of performing all of the operations included in the target query on the target data units as the pre-processing operation when the number of operations included in the target query is the second threshold number or less.

11. A query processing method, comprising:
generating a prediction query based on analysis information about history queries received from a host;
reading one or more of data units included in a data table corresponding to the prediction query from a storage device;
storing the data units read from the storage device in a buffer;
parsing a target query which is a query received from the host to generate target parsing information;
reading target data units, which are data units included in a data table corresponding to the target parsing information, from the buffer when the target data units are stored in the buffer; and
reading the target data units from the storage device when the target data units are not stored in the buffer.

12. The query processing method of claim 11, wherein the analysis information includes information about identifiers that are included in both a first history query and a second history query received from the host, and
wherein the first history query is the most recently received query among the history queries, and the second history query is a query received immediately before the first history query.

13. The query processing method of claim 12, wherein the analysis information includes first change information and second change information about each of the identifiers included in both the first history query and the second history query, and
wherein the first change information indicates whether at least one of an operator and a value corresponding to each of the identifiers is changed between the first history query and the second history query, and the second change information indicates whether at least one of the operator and the value corresponding to each of the identifiers is changed between the second history query and a third history query received immediately before the second history query among the history queries.

14. The query processing method of claim 13, wherein generating the prediction query comprises:
searching for a target identifier which is an identifier changed in both the first history query and the second history query based on the first change information and the second change information and,
when the search for the target identifier is successful, generating the prediction query.

15. The query processing method of claim 14, wherein generating the prediction query further comprises:
setting the identifiers that are included in both the first history query and the second history query as identifiers in the prediction query,
determining an operator and a value corresponding to the target identifier in the prediction query as an operator and a value corresponding to the target identifier in the second history query, and
determining an operator and a value of a remaining identifier, except for the target identifier, in the prediction query as an operator and a value corresponding to the remaining identifier, except for the target identifier, in the first history query.

16. The query processing method of claim 11, further comprising generating response data which is data to be transmitted to the host as a response to the target query,
wherein generating the response data comprises:
counting a number of operations included in the target query,
determining a pre-processing operation to be performed on the target data units based on a result of comparing the number of operations included in the target query with at least one of a first threshold number and a second threshold number, and
generating the response data by performing the pre-processing operation on the target data units,
wherein the first threshold number is larger than the second threshold number.

17. The query processing method of claim 16, wherein generating the response data further comprises:
determining an operation of extracting a portion corresponding to identifiers included in the target query in the target data units as the pre-processing operation when the number of operations included in the target query is larger than the first threshold number.

18. The query processing method of claim 16, wherein generating the response data further comprises:
determining an operation of performing the second threshold number of operations among the operations included in the target query on the target data units as the pre-processing operation when the number of operations included in the target query is the first threshold number or less and is larger than the second threshold number.

19. The query processing method of claim 16, wherein determining the response data further comprises:
determining an operation of performing all of the operations included in the target query on the target data units as the pre-processing operation when the number of operations included in the target query is the second threshold number or less.

20. A system, comprising:
a storage device storing one or more data tables, each of the data tables including one or more data units;
a buffer storing data units read from the storage device; and
a query predictor generating a prediction query based on analysis information about history queries received from a host, selecting a data table corresponding to the prediction query from the storage device, and reading one or more of data units included in the selected data table from the storage device and storing the read data units in the buffer.
